(19) United States
(12) Patent Application Publication
(10) Pub. No.: US 2025/0301280 A1
(43) Pub. Date: Sep. 25, 2025

(54) SYSTEMS AND METHODS FOR IMPLEMENTING AFC VIA GEOLOCATED ACCESS POINT DEVICES

(71) Applicant: PLUME DESIGN, INC., Palo Alto, CA (US)

(72) Inventors: Miroslav SAMARDZIJA, Mountain View, CA (US); Sean LI, Campbell, CA (US); Liem Hieu Dinh VO, San Jose, CA (US)

(21) Appl. No.: 18/613,527

(22) Filed: Mar. 22, 2024

(51) Int. Cl. H04W 4/029; H04W 48/16

(52) U.S. Cl. CPC H04W 4/029; H04W 48/16

(57) ABSTRACT

Disclosed are systems and methods that provide a decision-intelligence (DI)-based, computerized framework for determining the geolocation of a WiFi AP without using GPS information/data. The disclosed framework can operate to leverage positional information related to the location for which it is located and/or the devices for which that are connecting thereto, and based on computational analysis of such information, perform a periodic determination of its location, which can correspond to a positional range and/or a coordinate precise location. Accordingly, the disclosed computational analysis and determination can leverage WiFi links and/or data to/from the AP at the location to be part of the determination, and/or be used as a factor in performing the determination. Thus, the framework can perform operations implementing AFC via the geolocated AP devices.

### FIELD OF THE DISCLOSURE

The present disclosure is generally related to Wireless Fidelity (Wi-Fi or WiFi) network management at a location, and more particularly, to a decision intelligence (DI)-based computerized framework for implementing automated frequency coordination (AFC) by geolocating access point (AP) devices.

### SUMMARY OF THE DISCLOSURE

In a recent mandate by the Federal Communications Commission (FCC), “The 6 GHz Report and Order (FCC 20-51; 35 FCC Rcd 3852 (2020); 85 FR 31390 (May 26 2020)”, two different types of unlicensed wireless operations were authorized: i) standard-power and ii) indoor low-power operations. Standard-power operations, which encompass standard-power APs and fixed client devices (collectively referred to as standard-power devices in the Public Notice), are permitted in the 5.925-6.425 GHz and 6.525-6.875 GHz portions of the 6 GHz band and must operate under the control of an automated frequency coordination (AFC) system to prevent harmful interference to fixed microwave links that operate in the band. The standard-power devices are required to have a geolocation capability and, at least once per day, must communicate their location to an AFC system, which will provide them with the frequencies and maximum power levels at which they may operate without causing harmful interference to any microwave links. The AFC system must also prevent operation of standard-power devices in the 6.6500-6.6752 GHz band near a limited number of radio astronomy observatories.

In short, in order for WiFi APs (e.g., routers) to transmit at higher power levels (which is desired for range and throughput) in the 6 GHz band (6 GHz Band 5 and Band 7), the APs have to report at least once per day their geolocation to AFC System (e.g., there are now 16 approved AFC Systems) to assure there are no nearby wireless link in the same band that may be interfered.

Accordingly, as discussed herein via the disclosed systems and methods, usage of AFC can boost equivalent isotropic radiated power (EIRP) by up to 64× more than without the use of AFC. Moreover, as discussed herein via the disclosed functionality, up to 4 W can be transmitted by devices across a 320 MHz channel using standard power and AFC, while, in low power indoor (LPI) modes, devices can transmit 0.25 W across 80 MHz. More transmit power means more range (e.g., more signal-to-noise ratio, and hence more throughput).

WiFi APs, especially those made for home, are over-packed with WiFi, Bluetooth®, Matter, and other radios and antennas, leaving no room for a potential global positioning system (GPS) radio that can provide geolocation of the AP. In addition, the cost of adding GPS to an AP is significant and is desired to be avoided.

Accordingly, the disclosed systems and methods provide a novel framework for determining the geolocation of a WiFi AP without using GPS information/data. According to some embodiments, the framework can operate to leverage positional information related to the location for which it is located and/or the devices for which that are connecting thereto, and based on computational analysis of such information, perform a periodic determination of its location, which can correspond to a positional range and/or a coordinate precise location. Accordingly, as discussed herein, the disclosed computational analysis and determination can leverage WiFi links and/or data to/from the AP at the location to be part of the determination, and/or be used as a factor in performing the determination.

Thus, as discussed in more detail below, the disclosed systems and methods provide a novel implementation of dynamically controlling transmit power on WiFi devices (e.g., WiFi 7, for example) for optimal performance while complying with the FCC/AFC mandate.

According to embodiments of the instant disclosure, it should be understood that the discussion herein that references a location can correspond to, but not be limited to, a home, office, building and/or any other type of definable structure, zone, region and/or geographic location for which a wireless network (e.g., WiFi network, for example) can be provided and/or associated therewith.

According to some embodiments, a method is disclosed for a DI-based computerized framework for implementing AFC by geolocating AP devices. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for deterministically implementing AFC by geolocating AP devices.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configurations within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

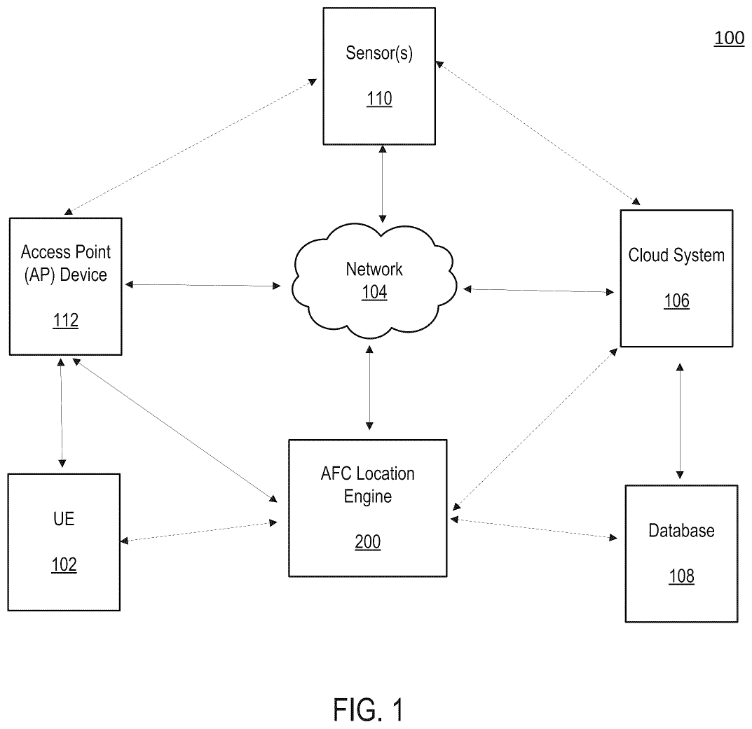

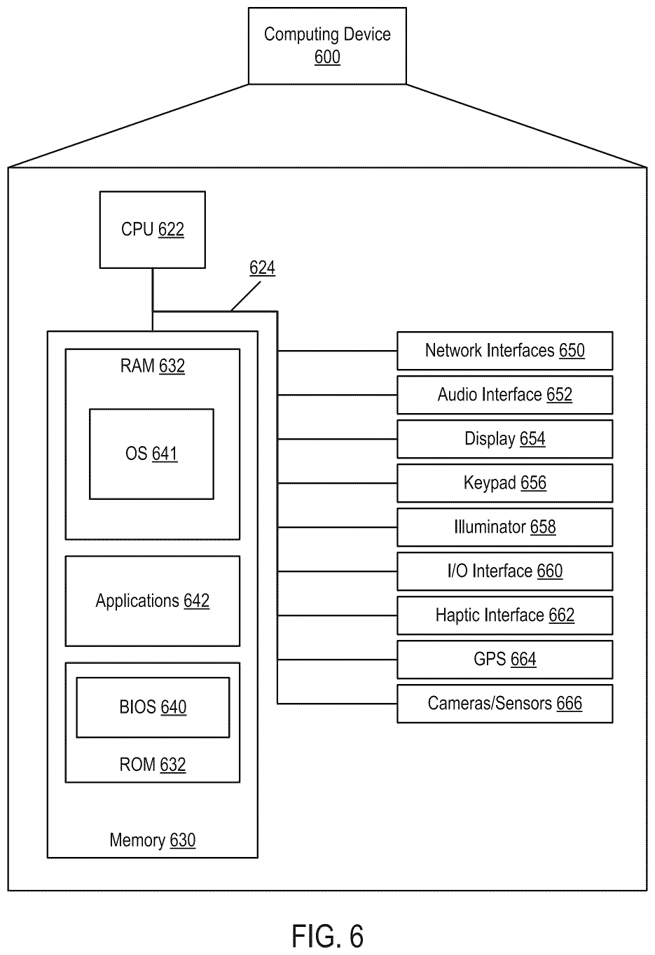

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), AP device 112, network 104, cloud system 106, database 108, sensors 110 and automated frequency coordination (AFC) engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IoT) device, wearable device, autonomous machine, smart television, media streaming device, game console, and any other device equipped with a cellular or wireless or wired transceiver.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

According to some embodiments, sensors 110 can correspond to any type of device, component and/or sensor associated with a location of system 100 (referred to, collectively, as “sensors”). In some embodiments, the sensors 110 can be any type of device that is capable of sensing and capturing data/metadata related to activity of the location. For example, the sensors 110 can include, but not be limited to, cameras, motion detectors, door and window contacts, heat and smoke detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. For example, the sensors 110 can include the sensors on UE 102 (e.g., smart phone) and/or peripheral device (e.g., a paired smart ring). In some embodiments, sensors 110 can be associated with any device connected and/or operating on cloud system 106 (e.g., a cloud-based device, such as a server that collects information related to the location, for example).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider (e.g., Plume Design®), which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, sensors 110, and the services and applications provided by cloud system 106 and/or AFC location engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

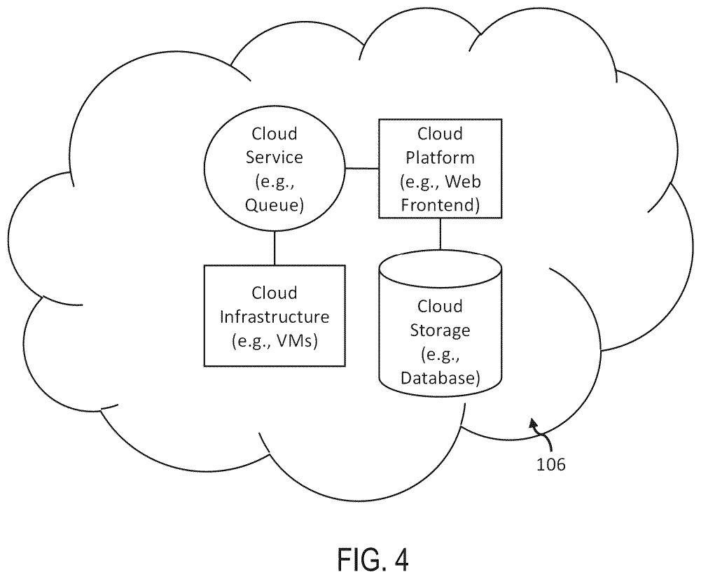

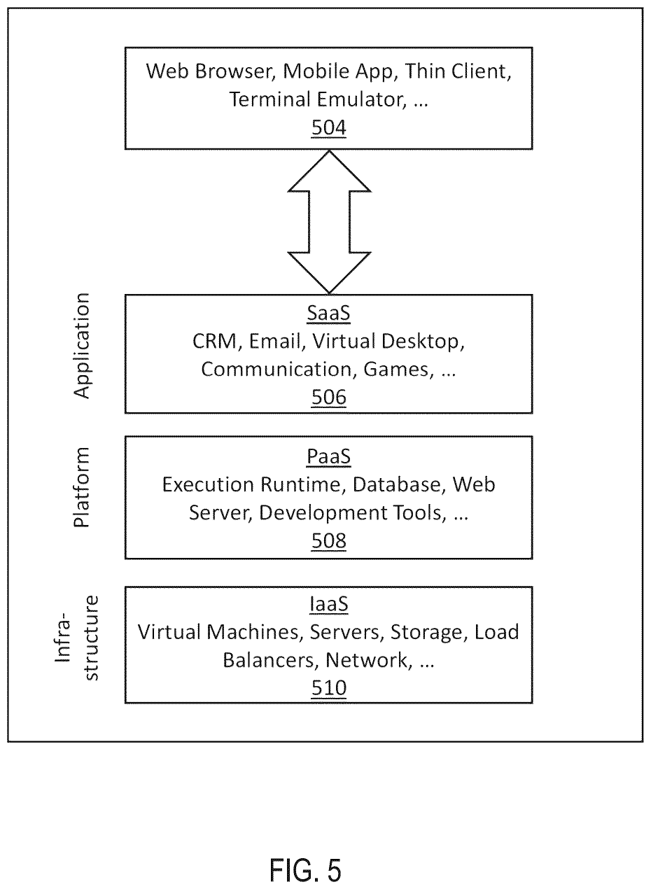

Turning to FIGS. 4 and 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIGS. 4 and 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

AFC location engine 200, as discussed above and further below in more detail, can include components for the disclosed functionality. According to some embodiments, AFC location engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, as discussed in more detail below, AFC location engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, AFC location engine 200 may function as an application provided by cloud system 106. In some embodiments, engine 200 may function as an application installed on a server(s), network location and/or other type of network resource associated with system 106. In some embodiments, engine 200 may function as an application installed and/or executing on AP device 112 and/or UE 102 (and/or sensors 110). In some embodiments, such application may be a web-based application accessed by AP device 112 and/or UE 102, and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on AP device 112, UE 102 and/or sensors 110.

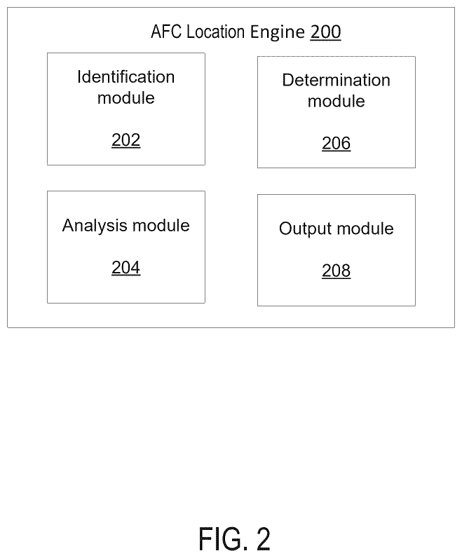

As illustrated in FIG. 2, according to some embodiments, AFC location engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

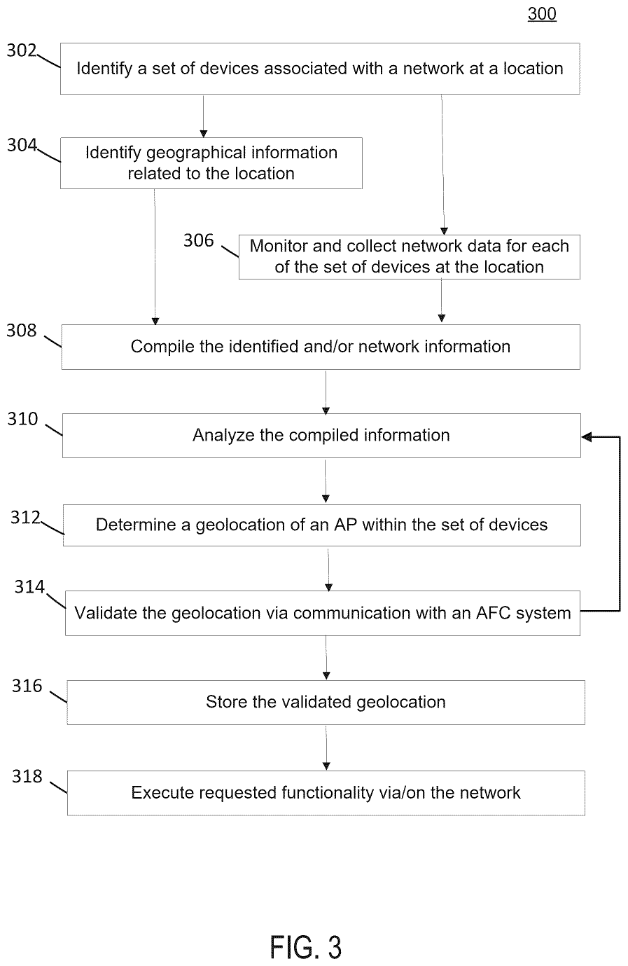

Turning to FIG. 3, Process 300 provides non-limiting example embodiments for the disclosed network management functionality, as discussed herein. As provided below, the disclosed framework's configuration and implementation can provide a computerized suite of AFC tools for managing network configurations, optimizations, connections, and the like.

According to some embodiments, APs can be deployed through various communication service providers (CSPs). Such CSPs can have contracts (e.g., internet for payment) with end-users, and therefore, such end-users physical home addresses where the internet is deployed (provided) is identifiable. Therefore, each AP (that has been deployed thru CSP and most are) can be associated to a physical home address.

Accordingly, as discussed herein, in some embodiments, the disclosed framework (via cloud system 106, for example) can extract, retrieve, determine or otherwise identify the home address for each AP (e.g., based on a CSP contract, for example), and map such address to a specific geolocation (e.g., longitude and latitude coordinates). In some embodiments, the framework can perform periodic (e.g., daily, for example) to an AFC system/server to update itself with a latest incumbent wireless links (e.g. links that care new, removed, added, modified, and the like, or some combination thereof), wherein such wireless links can provide point to point links in 6 GHz, for example. Such check, as discussed herein, can enable a determination as to whether such links are disrupted, which can be based on network disruptions or attributes, and/or location disruptions or attributes, whereby such links can be reestablished and/or refurbished.

According to some embodiments, Steps 302-304 of Process 300 can be performed by identification module 202 of AFC location engine 200; Steps 306-310 can be performed by analysis module 204; Steps 312 and 314 can be performed by determination module 206; and Steps 316 and 318 can be performed by output module 208.

According to some embodiments, Process 300 can begin with Step 302 where engine 200 can identify a set of devices associated with a network location. For example, the set of devices can include an AP device for a location that provides a network at the location (e.g., WiFi network for a home, for example), and UEs, as discussed in FIG. 1, discussed supra.

In Step 304, engine 200 can identify geographic information related to the location. Such geographic information can be based on, but not limited to, the AP, WiFi network, UE(s), CSP providing such WiFi network, and the like. For example, engine 200 can access an account of a user and/or AP, for example, then retrieve, or request and retrieve, then parse and extract information from network contract information for the WiFi network, as discussed above. In some embodiments, the network contract information can include and/or dictate functionality and/or capabilities for the network (e.g., download and/or upload speeds, as well as physical address information, as discussed herein). In some embodiments, engine 200 can retrieve initial location information from device identifiers and/or other forms of location information from and/or associated with devices connected to the AP.

In some embodiments, Step 304 can involve preparing a query that includes identifying information related to the WiFi network. Such query can be communicated to a cloud storage (e.g., database 108, discussed supra), where a network information data structure (e.g., contract, for example) can be retrieved. Engine 200 can analyze the contract and extract information related to the address of the location for which the network is configured, applied and/or available.

According to some embodiments, Process 300 can involve engine 200 proceeding from Step 304 to Step 308, where the location information determined in Step 304 is compiled for analysis by engine 200 to determine the geolocation, discussed infra.

In some embodiments, Process 300 can proceed to Step 306 as well, where engine 200 can monitor and collect network data for each of the set of devices at the location. In some embodiments, various types of network data can be monitored per a criteria, which can involve, or be based on, but not limited to, a time, date, event, application usage, type of device, type of AP, type of network, type of CSP, and the like, or some combination thereof. In some embodiments, such network data can be collected from other proximately located networks (e.g., local hotspots provided by proximately located devices (e.g., devices within the location that are hotspot capable), for example)).

In some embodiments, such network data can be utilized to determine the location of devices connected to AP, which can include, but is not limited to, signal strength data, including Received Signal Strength Indication (RSSI), which provides information about the strength of the wireless signal between the device and the access point. By triangulating the signal strength from multiple access points, the approximate location of the device can be estimated. In another non-limiting example, time difference of arrival (TDOA) data can be employed, where the time it takes for signals to travel between the device and multiple access points is measured. By comparing these time differences, the devices' location can be calculated. In another non-limiting example,

In another non-limiting example, angle of arrival (AOA) data can be utilized, which involves measuring the angle at which the device's signal arrives at multiple access points. This information allows for the determination of the devices' location based on the intersection of signal angles.

And, in another non-limiting example, network latency data, which refers to the time it takes for data packets to travel between the device and the AP, can be leveraged. Variations in latency can provide insights into the distance between the device and the access point, aiding in location estimation.

According to some embodiments, such determined/collected network data can be stored in database 108, as discussed supra.

In Step 308, engine 200 can compile the identified information (from Step 304), which can, in some embodiments, be compiled in conjunction with the collected data (from Step 306). Such compilation can involve generating a data structure input for computationally model execution to perform an analysis and determination of the AP/network's geolocation. Examples of how the compilation can execute and the information such compilation can generate is discussed below at least with reference to Step 312. In some embodiments, such compiled data structure can be stored in database 108, as discussed supra.

In Step 310, engine 200 can analyze the compiled information (from Step 308). In some embodiments, such analysis can involve engine 200 analyzing the compiled information by engine 200 executing a specific trained artificial intelligence (AI)/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Thus, based on the analysis of the collected data, in Step 310, engine 200 can determine the geolocation of the AP. According to some embodiments, as discussed above, the geolocation can correspond to longitude and latitude coordinates. Such coordinates can be stored in database 108, discussed supra.

According to some embodiments, with reference to Steps 310-312, AI and/or ML techniques can be executed in determining latitude and longitude coordinates from physical addresses. According to some embodiments, a dataset containing physical addresses along with their corresponding latitude and longitude coordinates can be collected and preprocessed to handle inconsistencies and errors (as in Step 304 and 308, supra). Features such as street names, city names, postal codes, and country names are then extracted and standardized for consistency across the dataset (as in Step 308).

In some embodiments, various ML models such as regression models, decision trees, random forests, support vector machines, or neural networks can be used for geocoding, depending on factors like dataset size and complexity. Such models can be trained on the preprocessed dataset to learn the relationships between input features (address components) and the target variable (latitude and longitude coordinates).

Thus, in some embodiments, AI/ML-based techniques such as cross-validation (e.g., fitting, pattern detection, and the like) can be employed to assess the accuracy and generalization performance of the trained model. Once validated, the AI/ML model is to predict latitude and longitude coordinates for new input addresses. Regular monitoring and updates ensure continuous improvement of the model, accommodating changes in data distribution or new address variations over time. Overall, AI/ML techniques significantly enhance the accuracy and efficiency of geocoding processes, particularly when dealing with large datasets or inconsistent address formats (which may occur given the manner the address is extracted—e.g., from a CSP contract, for example, as discussed supra).

According to some embodiments, Step 312 can involve leveraging the collected network data, as discussed above, for proximately located (e.g., ranged) 802.11b/g/n/a/z data (for example, 802.11 a/z data for 6 GHz WiFi bands). Such network data can be used to leverage and/or adjust the geolocation determinations for the AP. For example, the hotspot can have a geolocation determined, whereby such hotspot location can be construed/equated to the AP based on the 802.11 a/z ranging, which can occur via and/or based on transmission power data relationships between the positions of the hotspot and AP.

In Step 314, engine 200 can perform operations to validate the determined geolocation. In some embodiments, such validation can involve the AI/ML cross-validation techniques discussed above.

In some embodiments, Step 314 can involve engine 200 leveraging and/or communicating with an AFC system. According to some embodiments, an AFC system is a mechanism used in wireless communication systems to automatically adjust the frequency of a transmitter or receiver to maintain optimal performance. This adjustment is necessary to compensate for factors such as temperature changes, component aging, and external interference, which can cause the frequency of a device to drift away from its intended value.

In wireless communication, maintaining precise frequency alignment is crucial for ensuring reliable transmission and reception of signals. If the frequency drifts too far from the intended value, it can lead to degradation in signal quality, increased interference, and potential loss of communication.

AFC systems typically operate by continuously monitoring the frequency of the transmitted or received signals and making real-time adjustments to keep it within a specified range or target value. These adjustments can be achieved through various techniques, such as using voltage-controlled oscillators (VCOs) and/or phase-locked loops (PLLs) to control the frequency of the transmitter or receiver.

Overall, AFC systems play a vital role in maintaining the stability and reliability of wireless communication systems (e.g., APs) by ensuring that devices operate at their designated frequencies, even in challenging environmental conditions.

Accordingly, as in Step 314, the AFC system (which can correspond to a component, API and/or server associated with cloud system 106) can be utilized to validate geolocation information for an AP device by continuously adjusting the frequency of the APs radio transmission to maintain synchronization with the surrounding wireless environment. In the context of validating geolocation information, AFC serves as a mechanism to ensure that the AP's reported location aligns with its radio frequency behavior.

According to some embodiments, the AFC system operates by monitoring the frequency of signals received from the AP by nearby wireless clients or monitoring stations (and/or hotspots). Such signals contain information about the AP's frequency usage, which can be analyzed to infer the AP's location. If the reported location of the AP does not match the expected frequency behavior based on its surroundings, engine 200 can, based on information from the AFC system, suggest a potential discrepancy in the geolocation information. For example, if the reported location of an AP indicates that it should be operating in a certain frequency band, but the observed frequency behavior does not align with that location, it may indicate a misconfiguration or deliberate falsification of the AP's geolocation information. Accordingly, upon the detection of such improper geolocation, processing can proceed back to Step 310 to re-determine the geolocation based on, at least in addition to, the AFC determined information related to the improper geolocation.

Thus, by continuously monitoring and adjusting the frequency of the AP's radio transmission as in Step 314, the AFC system helps ensure that the AP is operating within its designated location as reported. This validation mechanism can be particularly important for regulatory compliance, security, and ensuring the integrity of location-based services provided by the AP.

Accordingly, as discussed above, Step 314 can involve AFC based analysis of the latest incumbent wireless links for the AP, wherein such wireless links can provide point to point links in 6 GHz, for example, for the AP (to the other devices in the set of devices, from Step 302). Such check, as per Step 314, can enable a determination as to whether such links are disrupted, which can be based on network disruptions or attributes, and/or location disruptions or attributes, whereby such links can be reestablished and/or refurbished.

In Step 316, engine 200 can store the validated geolocation information for the AP device. Such information can be stored in accordance with the CSP contract, as located and accessed from an account of the user as discussed above in Step 304.

And, in Step 318, AP can be facilitated, enabled and/or caused to operate the network and/or enable the execution of requests from connected devices, which will enable a more efficient execution of device and/or network resources. Accordingly, the AP can be configured, inclusive of how its radios are configured and/or transmitters/receivers operate, to operate at frequency bands/levels that align with the validated geolocation. The signals for the network can be curated to operate at optimal levels given the validated geolocation of the AP, therefore executed requests and/or applications can operate at preferred levels at the maximized/preferred values of network characteristics as enabled by the properly configured network for the location.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:

Aspect 1. A method comprising:
identifying a set of devices associated with a WiFi network at a location, the set of devices comprising an access point (AP) device;
accessing an account associated with the WiFi network, the account comprising information related to capabilities for the AP device to facilitate the WiFi network at the location;
determining, based on the information within the account, a physical address for the location;
analyzing the physical address, and determining, based on the analysis, a geolocation of the AP device; and
facilitating network activity via the AP device for connected devices within the set of devices based on a configuration of the AP device corresponding to the determined geolocation of the AP device.

Aspect 2. The method of aspect 1, further comprising:
performing a validation operation of the determined geolocation of the AP device, the validation comprising determining whether the network at the location is performing according to expected standards as associated with radios of the AP device in relation to the determined geolocation.

Aspect 3. The method of aspect 2, wherein the analysis of the physical address is performed again upon a determination that the validation indicates the expected standards are not met.

Aspect 4. The method of aspect 2, further comprising:
performing an adjustment to at least one of a transmitter and receiver of at least one of the radios to compensate for factors causing degradation of the network at the location, the adjustment enabling the validation of the geolocation.

Aspect 5. The method of aspect 4, wherein the factors include at least one of temperature changes, component aging and external interference.

Aspect 6. The method of aspect 2, wherein the validation of the determined geolocation is performed via execution of an automated frequency coordination (AFC) system, wherein the AFC system is a mechanism of a cloud system.

Aspect 7. The method of aspect 1, further comprising:
monitoring and collecting network attributes for the set of devices; and
performing the determination of the geolocation based further on the collected network attributes.

Aspect 8. The method of aspect 1, wherein the account corresponds to a communication service provider (CSP).

Aspect 9. The method of aspect 1, wherein the geolocation comprises longitude and latitude coordinates for the AP device.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying a set of devices associated with a WiFi network at a location, the set of devices comprising an access point (AP) device;
accessing an account associated with the WiFi network, the account comprising information related to capabilities for the AP device to facilitate the WiFi network at the location;
determining, based on the information within the account, a physical address for the location;
analyzing the physical address, and determining, based on the analysis, a geolocation of the AP device; and
facilitating network activity via the AP device for connected devices within the set of devices based on a configuration of the AP device corresponding to the determined geolocation of the AP device.

2. The method of claim 1, further comprising:
performing a validation operation of the determined geolocation of the AP device, the validation comprising determining whether the network at the location is performing according to expected standards as associated with radios of the AP device in relation to the determined geolocation.

3. The method of claim 2, wherein the analysis of the physical address is performed again upon a determination that the validation indicates the expected standards are not met.

4. The method of claim 2, further comprising:
performing an adjustment to at least one of a transmitter and receiver of at least one of the radios to compensate for factors causing degradation of the network at the location, the adjustment enabling the validation of the geolocation.

5. The method of claim 4, wherein the factors include at least one of temperature changes, component aging and external interference.

6. The method of claim 2, wherein the validation of the determined geolocation is performed via execution of an automated frequency coordination (AFC) system, wherein the AFC system is a mechanism of a cloud system.

7. The method of claim 1, further comprising:
monitoring and collecting network attributes for the set of devices; and
performing the determination of the geolocation based further on the collected network attributes.

8. The method of claim 1, wherein the account corresponds to a communication service provider (CSP).

9. The method of claim 1, wherein the geolocation comprises longitude and latitude coordinates for the AP device.

10. A system comprising:
a processor configured to:
identify a set of devices associated with a WiFi network at a location, the set of devices comprising an access point (AP) device;
access an account associated with the WiFi network, the account comprising information related to capabilities for the AP device to facilitate the WiFi network at the location;
determine, based on the information within the account, a physical address for the location;
analyze the physical address, and determining, based on the analysis, a geolocation of the AP device; and
facilitate network activity via the AP device for connected devices within the set of devices based on a configuration of the AP device corresponding to the determined geolocation of the AP device.

11. The system of claim 10, wherein the processor is further configured to:
perform a validation operation the determined geolocation of the AP device, the validation comprising determining whether the network at the location is performing according to expected standards as associated with radios of the AP device in relation to the determined geolocation.

12. The system of claim 11, wherein the analysis of the physical address is performed again upon a determination that the validation indicates the expected standards are not met.

13. The system of claim 11, wherein the processor is further configured to:
perform an adjustment to at least one of a transmitter and receiver of at least one of the radios to compensate for factors causing degradation of the network at the location, the adjustment enabling the validation of the geolocation.

14. The system of claim 13, wherein the factors include at least one of temperature changes, component aging and external interference.

15. The system of claim 11, wherein the validation of the determined geolocation is performed via execution of an automated frequency coordination (AFC) system, wherein the AFC system is a mechanism of a cloud system.

16. The system of claim 10, wherein the processor is further configured to:
monitor and collect network attributes for the set of devices; and
perform the determination of the geolocation based further on the collected network attributes.

17. The system of claim 10, wherein the geolocation comprises longitude and latitude coordinates for the AP device.

18. A non-transitory computer-readable storage medium tangibly encoded with computer-executable instructions that when executed by a processor, perform a method comprising:
identifying a set of devices associated with a WiFi network at a location, the set of devices comprising an access point (AP) device;
accessing an account associated with the WiFi network, the account comprising information related to capabilities for the AP device to facilitate the WiFi network at the location;
determining, based on the information within the account, a physical address for the location;
analyzing the physical address, and determining, based on the analysis, a geolocation of the AP device; and
facilitating network activity via the AP device for connected devices within the set of devices based on a configuration of the AP device corresponding to the determined geolocation of the AP device.

19. The non-transitory computer-readable storage medium of claim 18, further comprising:
performing a validation operation of the determined geolocation of the AP device, the validation comprising determining whether the network at the location is performing according to expected standards as associated with radios of the AP device in relation to the determined geolocation.

20. The non-transitory computer-readable storage medium of claim 19, wherein the validation of the determined geolocation is performed via execution of an automated frequency coordination (AFC) system, wherein the AFC system is a mechanism of a cloud system.
